(19) United States
(12) Patent Application Publication
(10) Pub. No.: US 2012/0237311 A1
(43) Pub. Date: Sep. 20, 2012

(54) METHOD AND APPARATUS FOR THERMAL CONTROL WITHIN A MACHINING PROCESS

(75) Inventors: Jason Dionne, Lakeville, MN (US); Dan Schiller, Woodbury, MN (US); David P. Jackson, Saugus, CA (US)

(73) Assignee: COOL CLEAN TECHNOLOGIES, INC., Eagan, MN (US)

(21) Appl. No.: 13/423,603

(22) Filed: Mar. 19, 2012

Related U.S. Application Data
(60) Provisional application No. 61/454,206, filed on Mar. 18, 2011.

(51) Int. Cl. B23Q 11/12

(52) U.S. Cl. 409/135

(57) ABSTRACT

Method and apparatus for mixing within a rotary union of a computer numerical control machine a constant pressure gas with a relatively higher-pressure, lower-temperature dense fluid to produce a dense isobaric fluid deliverable through a rotating tool without gelling or solidifying therein. The constant pressure gas may include carbon dioxide, nitrogen, air or mixtures thereof. The dense fluid preferably includes liquid carbon dioxide at or above its triple point. The liquid carbon dioxide and isobaric gas are independently fed to the rotary union. When mixed, a pressurized flowing carbon dioxide machining fluid composition is formed exhibiting a temperature between about 20° F. and 70° F. at pressures between 75 psi and 1,000 psi.

### CROSS-REFERENCE TO RELATED APPLICATION(S)

This application claims the benefit of U.S. Provisional Patent Application No. 61/454,206 filed on 18 Mar. 2011, which is hereby incorporated herein by reference.

### BACKGROUND OF INVENTION

The present invention relates to metalworking or machining processes, such as through the use of drills, lathes, grinders, milling and hard-turning apparatuses. More particularly, the present invention relates to the thermal control of a coolant or minimum quantity lubricant within the metalworking or machining process.

The use of computer numerical control (CNC) machining tools within metalworking and machining processes has drastically increased over the past two decades, and shows ever increasing applications. CNC machines, with the assistance of computer aided drafting (CAD), can machine a block of metal into an infinite number of different shaped parts. One such CNC machine includes a setup wherein a block of metal is positionably suspended within a rotatable lathe-type apparatus. A rotatable cutting tool, connected to an arm via a rotary coupling, is positionable to contact and thus machine the metal block. Both the positioning of the lathe and the rotating cutting tool are controlled by the CNC machine.

The predominant mode of cooling and lubricating during machining involves the flooded application of metalworking fluids. Large volumes of metalworking fluids are simply sprayed onto the cutting tool and cutting surface to affect both cooling and lubricating thereon. Not only are such techniques messy during application and produce large waste streams which have to be recycled, but due to the ever increasing complexity of CNC machining and the number of moving parts, it has become quite difficult to position nozzles and feed lines to properly apply the flooded coolant or lubricant. Often times, the moving parts of the CNC machine contact the nozzles or feed lines, causing damage which require repairs, realignment and downtime. Also, flooded applications are quite difficult to control during micro-machining or high-precision applications. With respect to at least the high-precision machining applications, with tolerances less than a micrometer, it has become common to employ minimum-quantity lubrications (MQL) or near-dry machining (NDM). The purpose of MQL and NDM is to apply only the amount of coolant or lubricant needed to properly control the amount of heat created by the friction between the tool and part interface.

There exist in the art examples of MQL and NDM processes utilizing lubricants and cryogenic fluids which are fed through the tool. The use of cryogenics, for example liquid or solid carbon dioxide, has been found to be quite effective in providing both cooling and lubricating properties. However, with regard to rotating tools having a spindle attached to a rotary coupling, it has been difficult to employ cryogenic fluids. Because the cryogenic fluid enters the tool through the rotary coupling, the spindle or rotary coupling experiences a great difference in temperature relative to the ambient air, which in turn can lead to condensation or frosting on external surfaces, or clogging of nozzles. This problem is exacerbated if an oil or other lubricant is mixed with the cryogenic fluid, which must be done at or before the rotary coupling, and the oil or lubricant tends to become quite viscous or freezes entirely before exiting the tool. Without the use of cryogens, prior art processes tend to be time consuming and quickly wear down cutting tools. This not only adds to replacement costs, but more importantly, diminishes overall quality of the machining process, especially where extremely high precision is needed.

Moreover, conventional cooling fluids, such as water-oil emulsions, are first refrigerated ex-situ and then transported internally to the cutting zone, cooling everything along its path and introducing secondary waste, maintenance and cleaning issues. Refrigerated air is typically not used in long through-system coolant networks because it is ineffective due to its low heat capacity. Typically, cooled gases are simply sprayed externally over the cutting zone and do not necessarily enter the actual tool-chip interface. With regards to liquid carbon dioxide processes, liquid carbon dioxide requires very high pressure system components and a through-system temperature of less than 30° Celsius. Subsequently, system heat and rotary seal compatibility issues can become a significant constraint using this conventional approach. The same is true and exaggerated for supercritical carbon dioxide. More important, additive schemes become extremely limited due to the selective solubility of both liquid and supercritical carbon dioxide coolants. Still moreover, conventional coolant approaches do not provide the productivity needed in today's highly competitive business climate. Heat is the enemy of productivity in many processes and generally too much heat leads to quality control problems.

It is therefore an object of the present invention to overcome both internal and external icing problems as experienced in the prior art using dense phase carbon dioxide fluids. It is a further object of the present invention is to provide a method and apparatus to transport a dense fluid through a rotating tool during a machining process at temperatures above 20° F. (−7° C.) such that the dense fluid can lubricate and/or remove excess process heat at the tool-substrate or tool-chip interfaces. Finally, it is an object of the present invention to prevent premature liquid or solid particle formation within internal coolant passageways of a coolant network prior to exiting a cutting tool, which can cause equipment malfunction with catastrophic consequences.

### BRIEF SUMMARY OF INVENTION

The present invention provides a method of mixing within a rotary union of a computer numerical control (CNC) machine a constant pressure gas with a relatively higher-pressure, lower-temperature dense fluid to produce a dense isobaric fluid deliverable through a rotating tool without gelling or solidifying therein. The constant pressure gas may include carbon dioxide, nitrogen, air or mixtures thereof. The dense fluid preferably includes liquid carbon dioxide at or above its triple point of −58° F. (−50° C.) and 74 psi (5 atm). The liquid carbon dioxide and isobaric gas are independently fed to the rotary union. When mixed, a pressurized flowing carbon dioxide machining fluid composition is formed exhibiting a temperature between about 20° F. (−7° C.) and 70° F. (21° C.) at pressures between 75 psi (5 atm) and 1,000 psi (68 atm). Optionally, lubricants may be added to the mixture. The mixture is deliverable through the rotating spindle without gelling or solidifying therein. Upon exiting ports positioned in or proximate the tool, the machining fluid instantly condenses under reduced ambient pressure conditions, forming a mixture of solid carbon dioxide particles and gas capable of removing heat from the tool/cutting surface interface as well as providing lubricating properties thereto.

### BRIEF DESCRIPTION OF THE DRAWINGS

FIG. 1 is a chart illustrating the Joule-Thompson coefficient versus temperature for several gases.

FIG. 2 is a diagram illustrating a method according to the present invention.

FIG. 3 is a diagram illustrating a first alternative method according to the present invention

FIG. 4 is a cut-away view of an exemplary CNC assembly according to the present invention.

FIG. 5 is a diagram illustrating a second alternative embodiment of the present invention.

### DETAILED DESCRIPTION

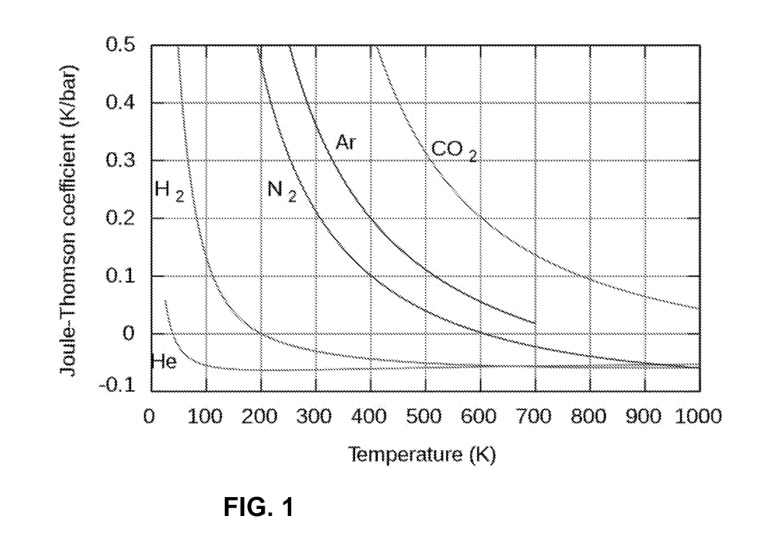

The present invention employs an in-situ Joules-Thomson cooling effect at a tool/substrate interface, preferably in a turning machining operation. As illustrated in FIG. 1, the Joule-Thomson coefficient, or the change in temperature per unit change in pressure, is not a constant and is highly variable for any particular gas mixture depending on the starting and ending conditions. Carbon dioxide has the highest Joule-Thomson coefficient among most conventional fluids. Under large pressure changes, the temperature of the gaseous carbon dioxide fluid, or a mixture containing a trace amount of lubricant additive and/or compressed air, can fall to a point where the carbon dioxide as vapor or as a component of the mixture condenses into a liquid, or to solid carbon dioxide particles, depending upon the differential pressure produced and resulting Joule-Thomson cooling effected. While it is preferable that the lubricant be a non-aqueous oil lubricant, it is well within the scope of the present invention to provide conventional oil-water emulsion coolants as the lubricant as well. Non-exhaustive examples of non-aqueous lubricants include, but are not limited to, bio-based oils, synthetic oils, semi-synthetic oils, petroleum-based oils including mineral oil, alcohol esters including soy methyl esters, tetrahydrofufuryl alcohol and ethyl lactate, alcohols including ethanol, ketones including acetone, polyglycols, phosphate esters, hydrocarbons and silicones. An exemplary non-aqueous lubricant includes those as sold under the BOELUBE® line of products as made commercially available through The Oreolube Corporation of Bellport, N.Y. More particularly, non-exhaustive examples of bio-based oils include, but are not limited to, vegetable oils including corn oil, soybean oil, sunflower oil, peanut oil, safflower oil, flaxseed oil and canola oil. Exemplary bio-based oils include those as sold under the COOLWAY™, NUTCUT™ and SOYEASY™ line of products as made commercially available through Environmental Lubricants Manufacturing, Inc. of Cedar Falls, Iowa. Optionally, other additives may be added to any of the aforementioned lubricants including, but not limited to, oxidation inhibitors, corrosion inhibitors, rust inhibitors, extreme pressure agents including chlorinated paraffinic oils, boron nitride, molybdenum disulfide, polytetrafluoroethylene, pour point additives, detergents, dispersants, foam inhibitors, trace amounts of water, and any combinations thereof.

The in-situ Joule-Thomson cooling effect of the present invention is controlled precisely to prevent premature liquid or solid particle formation within internal coolant passageways of the coolant network, which can cause equipment such as bearings or seals to malfunction or be damaged with potential catastrophic consequences. It was discovered by the present inventors that by providing a constant flow at a selected rate of gaseous carbon dioxide or compressed air fluid at a constant pressure greater than the triple point pressure of carbon dioxide, the clogging was eliminated. The carbon dioxide fluid must therefore remain above the saturation temperature under a predetermined isobaric pressure and flow rate until exiting the internal coolant network, for example through the cutting tool and into the cutting zone which is at atmospheric conditions. By providing this isobaric overpressure, it was discovered that the carbon dioxide coolant and/or lubricant were able to pass through the bore and form solid carbon dioxide particles immediately upon exiting the port or ports in the tool. Higher overpressure conditions, for example 100 psi (6.8 atm) or more, provide higher Joule-Thomson temperature reductions using the present invention. Temperatures within the internal network range between approximately 20° F. (−6.5° C.) and 60° F. (15.5° C.) when at about 400 psi (27 atm). It was discovered that a relatively higher temperature and relatively lower pressure overpressure gas can be used to control the temperature internal to a computer numerical control (CNC) network components without gelling or freezing. The relatively large volume of overpressure gas compared to the volume of boiling liquid carbon dioxide maintains a CNC network temperature of at least 20° F. (−6.5° C.), and preferably 40° F. (4° C.) or greater. Thus, controlling the pressure and flow rate of the overpressure controls the temperature internal to the CNC network. Essentially, a relatively lower-pressure and higher-temperature gas is mixed with a boiling liquid carbon dioxide to produce a dense isobaric fluid flow within the CNC machining system without bringing the temperature below 20° F. (−6.5° C.). The amount of cooling produced at the cutting tool 34 and cut zone can be controlled by the amount of liquid carbon dioxide delivered through conduit 28. Also, the coolant ports within the cutting tool 34 impact the production of solid carbon dioxide crystals. Restricting the diameter of the coolant ports aids in maintaining the overpressure inside the CNC network. Restricting the flow rate of the dense isobaric fluid can be performed at the immediate exit of the cutting tool or relatively close to the cutting tool, including internal to the tool holder 32. The relatively high flow rate of the overpressure gas will carry any solid carbon dioxide crystals out of the cutting tool 34 through larger coolant ports designed for prior art coolant systems.

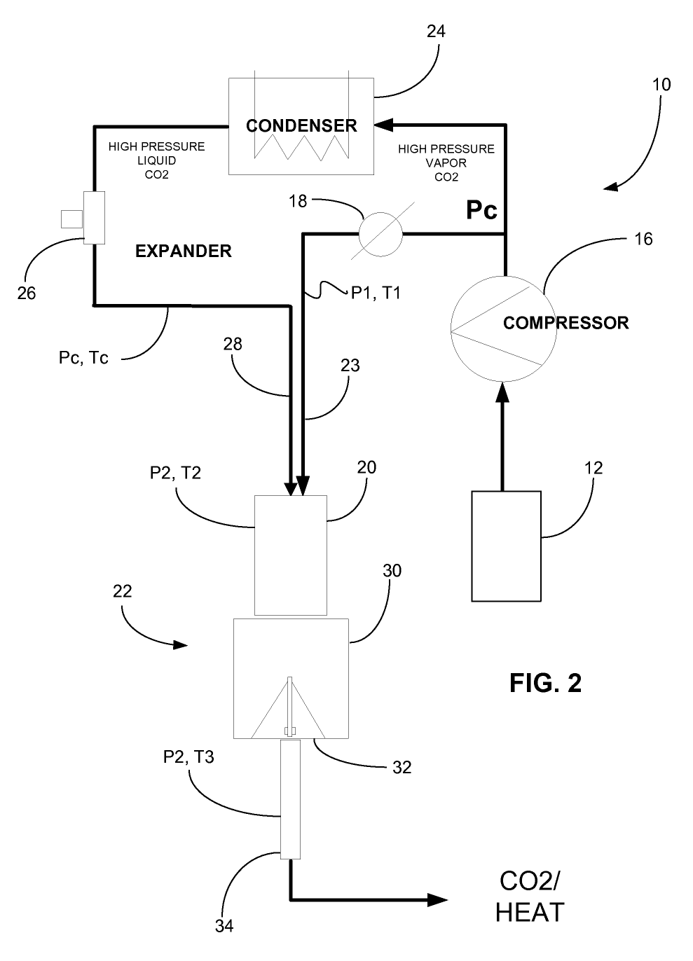

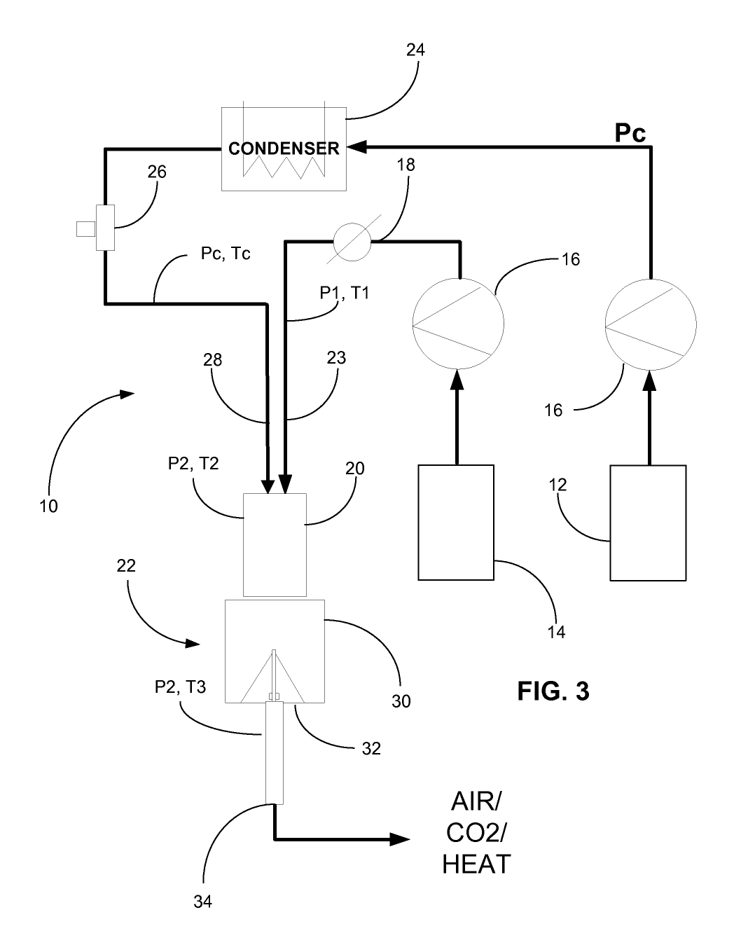

A machining coolant network in accordance with the present invention is generally indicated at 10 in FIGS. 2 and 3. The coolant network generally includes a means for forming an over-pressure gas supply and a dense fluid. In FIG. 2, to form the overpressure gas supply, the coolant network includes a bulk source 12 of carbon dioxide gas having a pressure of approximately 300 psi and a temperature of approximately −4° F. (−20° C.). Alternatively, and as illustrated in FIG. 3, a supply of carbon dioxide, nitrogen or air 14 can be used to form the overpressure gas. The gas, either carbon dioxide, nitrogen, air or mixtures thereof, is fed into an OEL booster pump 16, for example a ChilAire Amp System as made available through Cool Clean Technologies, LLC of Eagan, Minn. The booster pump 16 compresses the gas to form a supply of isobaric over-pressure gas at a pressure Pc of between about 700 psi and 1,000 psi and a temperature T1 of between about 60° F. (15° C.) and 122° F. (50° C.). A pressure regulator 18 and intercooler (not shown) are used to feed a rotary union 20 of a CNC machining tool 22 with the over-pressure gas at a pressure P1 of between about 75 psi (5 atm) and 1,000 psi (68 atm) and a temperature T1 between about 60° F. (15° C.) and 122° F. (50° C.). The over-pressure gas is preferably constantly fed into the rotary union via conduit 23 at a flow rate of between 0.4 and 100 standard cubic feet per minute (scfm) (10 and 2,800 liters), and more preferably at between 0.4 and 30 scfm (10 and 850 liters).

To form the dense fluid carbon dioxide, a portion of the over-pressure carbon dioxide gas is fed from the booster pump into a condenser 24, which removes excess heat and condenses the over-pressure fluid into a supply of relatively colder, gas-saturated liquid carbon dioxide having a pressure Pc of between about 700 psi and 1,000 psi and a temperature Tc of between about 14° F. (−10° C.) and 50° F. (10° C.). An exemplary condenser includes a ChilAire EI3100 as made available by Cool Clean Technologies, LLC of Eagan, Minn. The liquid carbon dioxide is then fed through either a mass flow metering valve or a stepped capillary 26, into the rotary union 20 of the CNC machine 22 via a capillary tube 28. The stepped capillary is preferably that as disclosed in commonly owned U.S. Pat. No. 7,293,570, the entirety of which is incorporated herein by this reference. The capillary tube 28 may be optionally insulated. The capillary tube 28 preferably has a diameter of between 0.010 inches (0.03 cm) and 0.250 inches (0.64 cm) and a length of between 1 inch (2.54 cm) and 576 inches (1,463 cm). However, longer lengths are within the scope of the present invention, dependent upon the placement of the condenser in proximity to the CNC machine. The metering valve 26 or stepped capillary is used to control the flow rate of boiling liquid carbon dioxide injected through the capillary tube 28 into the rotary union 20. It is also within the scope of the present invention to provide a plurality of capillary tubes 28 in fluid communication with the rotary union 20, as may be used to provide the necessary mass flow rate to accommodate the necessary heat removal at the tool/substrate interface. An injection feed rate of liquid carbon dioxide can be controlled between about 3 lbs/hour (1.36 kg/hr) to 150 lbs/hour (68 kg/hr) or more using this scheme.

The liquid carbon dioxide entering the rotary union 20 experiences a pressure drop wherein a portion of the liquid immediately changes phase from a boiling liquid into gas. However, the isobaric over-pressure gas supplied to the rotary union at pressure P1 of at least 75 psi (5 atm) and between temperature T1 of about 60° F. (15° C.) and 122° F. (50° C.) prevents the liquid carbon dioxide from forming solid particles during this phase change. The magnitude of the temperature change of the resultant fluid mixed within the rotary union 20 is dependent upon the starting pressures and temperatures of the overpressure gas and pressure P1 and temperature T1 fed through line 23, and the dense fluid and pressure Pc and T1 fed through line 28, as well as the composition of the mixture fluids (for example, pure carbon dioxide versus carbon dioxide mixed with air). The heat absorbed by the liquid carbon dioxide from line 28 upon injection into the rotary union 20 forms an isobaric over-pressure fluid mixture at pressure P2 and a temperature T2 greater than 20° F. (−7° C.), preferably between 40° F. (4.4° C.) and 60° F. (15.5° C.). To prevent premature formation of solid carbon dioxide particles, or gelling of optional lubricant additives within the mixture, the flow rate of the overpressure gas is selectively modified by pressure regulator 18 to accommodate the mass flow rate of the liquid carbon dioxide entering the rotary union 20 via line 28. An increase in the relatively warmer overpressure gas will accommodate a greater mass flow rate of the liquid carbon dioxide to achieve a temperature T3 of the overall mixture greater than 40° F. (4.5° C.). The resultant mixture exhibits a precise temperature, preferably above the temperature of the freezing point of the coolant or lubricant, under isobaric fluid pressure and constant flow rate.

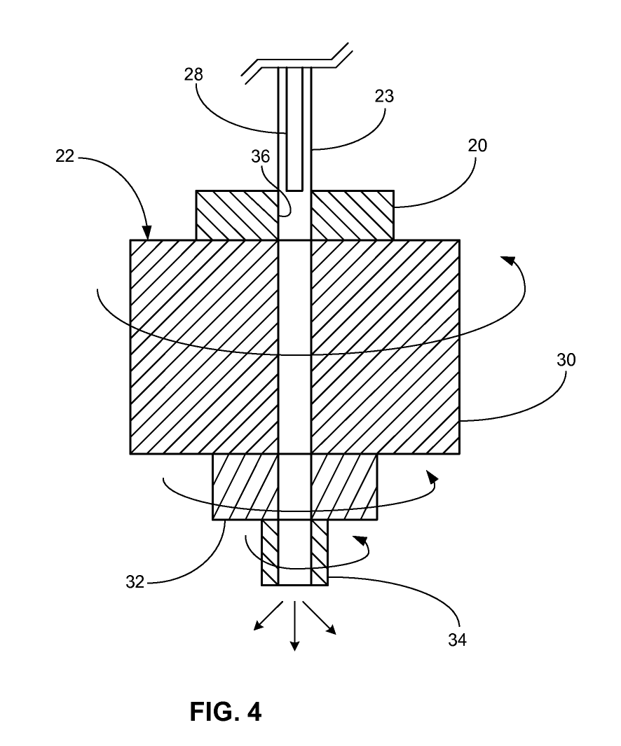

As best illustrated in FIG. 4, in addition to the rotary union, the CNC coolant network includes a spindle 30, tool holder 32 and cutting tool 34. As previously described, the booster 16 feeds the rotary union 20 of CNC machining tool 22, via line 23, the overpressure gas whose flow rate is controlled by the regulator 18. The condenser 24 forms dense phase carbon dioxide which is fed through the second conduit 28 into the rotary union 20, the flow rate of which is controlled by metering valve or stepped-capillary 26. Both conduits 23, 28 are in fluid communication with a passageway or through-bore 36 extending through the rotary union 20, spindle motor 30 and tool holder 32. The through-bore 36 may also extend through the cutting tool 34. However, providing an exit port for the coolant/lubricant that does not extend through the cutting tool itself, but in close proximity to the cutting tool is well within the scope of the present invention.

As mentioned, the employable overpressure gases include carbon dioxide, nitrogen, air, or a mixture thereof. The second conduit 28 terminates near the entry into the rotary union coupling 20, as illustrated in FIG. 4, but may terminate farther into the rotary union coupling assembly. Termination of the second conduit 23 preferably occurs within a non-rotating component of the CNC network. While it is illustrated that a coaxial, or tube-in-tube, connection is used to introduce the liquid carbon dioxide and pressured gas into the rotary union 20, other configurations are well within the scope of the present invention, including providing separate conduits and entry points into the rotary union. The expansion of the liquid carbon dioxide into the gaseous fluid within the rotary union 20 produces an overall cooling fluid exhibiting a temperature greater than 20° F. (−7° C.), preferably between 40° F. (4.4° C.) and 60° F. (15.5° C.). The overall cooling fluid contains a mixture of solid carbon dioxide particles and gas capable of removing heat from the tool/cutting surface interface as well as providing lubricating properties thereto.

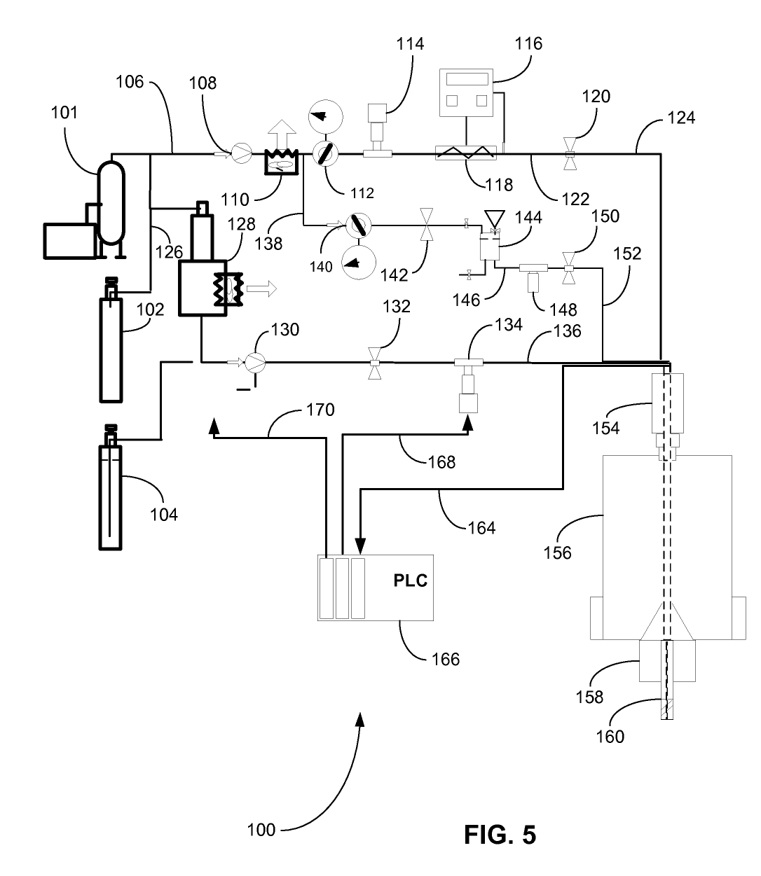

Referring now to FIG. 5, a schematic of an alternative embodiment 100 of the present invention is illustrated. Coolant component fluid sources for establishing an overpressure fluid and an expansion coolant are derived from separate sources of compressed air or nitrogen gas 101, saturated carbon dioxide gas 102, and gas-saturated liquid carbon dioxide 104. It should be noted that carbon dioxide vapor 102 and liquid carbon dioxide 104 may be withdrawn separately from a single supply source such as a low-pressure Dewar of liquid carbon dioxide at 300 psi and 0° F. (−18° C.) (not shown).

The over-pressure gas is derived from either carbon dioxide gas 102 or compressed air or nitrogen 101, as previously described herein. The over-pressure gas source is fed via pipe 106 and into a compressor pump 108, which compresses the gas to a pressure of between 150 psi (10 atm) and 600 psi (40 atm) for air or nitrogen, or between 700 psi (47 atm) and 1,000 psi (68 atm) for carbon dioxide. Compression heat is removed using a heat exchanger 110 and pressure-regulated to the desired over-pressure conditions using pressure regulator 112. A mass flow controller 114 may be used to control flow of pressure-regulated over-pressure fluid. Following pressure and flow regulation, the over-pressure fluid may be heated or cooled to provide precise temperature control of over-pressure fluid using a temperature controller 116 and heater or cooler unit 118. A control valve 120 is used to control the flow of pressure, flow and temperature-regulated over-pressure fluid flowing through pipe 122 into the CNC coolant network via inlet over-pressure fluid pipe 124.

The expansion cooling agent liquid carbon dioxide 104 may be withdrawn directly from a source derived from a high pressure supply cylinder as shown. However this may not be desirable in certain factory settings due to the relatively low capacity available and the dangers of locating high pressure steel cylinders near process equipment and personnel. More preferably, a low-pressure source of carbon dioxide gas at a pressure of approximately 300 psi may plumbed from a remote location via inlet pipe 126 and compressed to between 700 psi (47 atm) and 1,000 psi (68 atm) using a booster pump (not shown) and fed into a condenser unit 128 to generate a supply of gas-saturated liquid carbon dioxide. The liquid carbon dioxide contained in the condenser unit 128 may be pumped to higher pressures if need be, for example to as high as 1500 psi (102 atm), using a small liquid booster pump 130 as made available from Haskel International of Burbank, Calif., and transported through a shutoff valve 132, through mass flow control metering valve 134, into a an expansion capillary device 136 and into the exemplary CNC coolant network.

Optionally, lubricant additives may be introduced. In a first method of introducing lubricant additives, a lubricant additive of compressed air, nitrogen or carbon dioxide gas are plumbed via lubrication pipe 138, through lubrication pressure regulator 140, lubrication pressure shutoff valve 142 and into a gas-liquid lubricator 144. Lubricated gas is fed through lubrication pipe 146, through micrometering flow control valve 148 and shutoff valve 150, and into the CNC coolant network via inlet lubrication capillary tube 152. In a second method of introducing lubricant additives, a positive displacement pump (not shown) is used to inject the additive directly into the carbon dioxide capillary 136 downstream from shutoff valve 132. This method allows the additive to mix with or form a layer around the liquid carbon dioxide droplets that are formed within the capillary 136. The mixture can then supply the additive to the seals, bearings or the cut zone as required.

The exemplary CNC machining coolant network comprises a through-ported rotary union 154 connected to a through-ported spindle motor 156. The CNC machine further includes a through-ported tool holder 158 connected to a through-ported cutting tool 160. Carbon dioxide refrigeration system fluid components are connected to the exemplary CNC machining coolant network using a multi-ported rotary union 154. Over-pressure fluid delivery pipe 124, lubrication feed pipe 152, and JT expansion cooling fluid capillary 136 are affixed to one of several ports of the rotary union 154. Optionally, a thermocouple 164 may be fed through said multi-ported rotary union 154 to measure temperature of the over-pressure fluid.

A PLC 166 may be integrated to the system to monitor and control the various components of the carbon dioxide vapor compression refrigeration process. PLC system sensor inputs such as thermocouple 164 or infrared thermometer (not shown), pressure transducer, and control outputs such as operating compressors and regulators 168 and micrometering valves 170 may be employed to provide automatic monitoring and control capability. A CNC machine controller (not shown) would be interfaced with the PLC to input M-code for coolant on/off functions as well as receive any important output information such as coolant temperatures and pressures.

### EXAMPLES

### Example 1

Several tests were performed to determine the efficiency of the present invention. The tests were performed on a CNC milling machine. Test cuts were made with tool steel. Test cuts were performed to verify the CNC machine program was configured properly. Once the programming was verified, Control Runs were performed with 6AL4V Titanium. For this phase of testing, ten block of 6AL4V Titanium were available and were all used during the different test cuts.

### Control Run

A first control run was done using flood techniques of the prior art. The below machining specifications for each cut have been optimized to provide a balance of productivity and tool life for this material and coolant/lubrication system. Five control test pieces were machined to verify repeatability.
Tooling: Face mill; 2″ diameter; 4 inserts; approximately 0.118″ diameter coolant port for each insert.
Insert: Ultra Tool 61012TA round insert for Ti
Spindle Speed: 600 rpm
Feed rate: 0.010″/insert
Cut Depth: 0.075″
Cutting feet per minute: 314 SFPM

These machining parameters are at the limit of the capabilities of the tooling and inserts. Increasing any of the parameters will significantly impact the life of the inserts and quality of cut.

### Test Run

Tests were performed employing the method of the present invention using a ChilAire EI3100 and ChilAire Amp system, as made available by Cool Clean Technologies, LLC, to supply and control the liquid carbon dioxide and overpressure gas to the rotary union. The overpressure carbon dioxide gas was supplied at about 400 psi, while the liquid carbon dioxide was supplied at about 850 psi. Five test run pieces of 6AL4V Titanium were cut with the same style tooling and same inserts as detailed in the control runs. One difference in the face mill was the size of the coolant ports. The 4 coolant ports were modified to result in a diameter of approximately 0.022″. Machining specifications were kept constant during the first 3 test runs to verify repeatability and to verify the performance of the invention was at least as good as the control run system. For the 4^{th} and 5^{th} test runs, the spindle speed was increased to demonstrate reduced cycle time and therefore increased productivity without sacrificing tool life. It was discovered that the spindle speed could be increased up to 60%, with negligible wear on the inserts. The increased spindle speed of 960 rpm resulted in a cutting speed of 503 surface feet per minute.

### Example 2

A CNC coolant network in accordance with the present invention was used to test drilling of stacked titanium and carbon fiber reinforced plastic (CFRP) stack-ups. A 0.50 inch titanium plate having a thermocouple affixed thereto was drilled with a ported 0.25 inch diameter, uncoated carbide drill bit. The bit was run by a Cooper air-driven spindle and motor. The air-driven drilling system was adjusted to run at a drilling speed of approximately 600 rpm and at a drilling feed rate of approximately 1 inch per minute with no pecking

A machining coolant network of the present invention employing 100% carbon dioxide with a carbonated MQL lubricant additive of BOELUBE® was used as follows:
Carbon dioxide over-pressure: 300 psi
Liquid carbon dioxide injection feed: 3 pounds/hour
Lubricant injection rate: 25 mls/hour

After a series of drilling tests to optimize the set-up, an actual drilling test series comprising 3 holes each was performed comparing the present invention to a standard air-lubricant MQL machining BOELUBE® against the method of the present invention. The results of the test demonstrated an approximate 60° F. (15.5° C.) reduction in temperature as compared to identical side-by-side machining tests using a bio-based ester lubricant in air coolant mixture. The results of the process demonstrated the capability to drill cooler, which translates into better surface finishes and longer tool life. Also cooler drilling operation enables faster speed and feed rate drilling operations with the same expected tool life.

Although the present invention has been described with reference to preferred embodiments, workers skilled in the art will recognize that changes may be made in form and detail without departing from the spirit and scope of the invention.

1. A method of mixing within a rotary union of a computer numerical control machine a dense machining fluid deliverable through a rotating tool without the dense machining fluid solidifying therein, the method comprising the steps of:
supplying the rotary union with a dense fluid;
supplying the rotary union with a gas at a temperature greater than the dense fluid; and
mixing the dense fluid with the gas to form the dense machining fluid, the dense machining fluid exhibiting a temperature between about −7° C. and 21° C.

2. The method of claim 1 wherein the dense machining fluid exhibits a temperature between 4.4° C. and 15.5° C.

3. The method of claim 1 whereupon exiting the tool the dense machining fluid forms a mixture of solid particles and gas for the removal of heat from an interface between the tool and cutting surface.

4. The method of claim 1 wherein supplying the rotary union with the dense fluid includes liquid carbon dioxide supplied at or above its triple point of −50° C. at a pressure between 5 atm and 68 atm.

5. The method of claim 1 and further comprising the steps of:
supplying the rotary union with a lubricant; and
mixing the lubricant with the dense fluid and gas to form the dense machining fluid, the dense machining fluid exhibiting a temperature greater than a freezing temperature of the lubricant.

6. The method of claim 1 and further comprising the step of regulating the pressure and flow rate of the gas to control the temperature of the dense machining fluid.

7. The method of claim 1 wherein the gas is supplied to the rotary union at a pressure of at least 5 atm and a temperature between 15° C. and 50° C.

8. The method of claim 7 wherein the dense fluid is prevented from forming solid particles upon entering the rotary union.

9. A method of mixing within a rotary union of a computer numerical control machine a dense machining fluid deliverable through a rotating tool without the dense machining fluid solidifying therein, the method comprising the steps of:
supplying the rotary union with liquid carbon dioxide supplied at or above its triple point of −50° C. at a pressure between 5 atm and 68 atm;
supplying the rotary union with a gas at a pressure less than the pressure of the incoming liquid carbon dioxide and at a temperature between 15° C. and 50° C.; and
mixing the dense fluid with the gas to form the dense machining fluid, the dense machining fluid exhibiting a temperature between about −7° C. and 21° C.

10. The method of claim 9 and further comprising the steps of:
supplying the rotary union with a lubricant; and
mixing the lubricant with the liquid carbon dioxide and gas to form the dense machining fluid, the dense machining fluid exhibiting a temperature greater than a freezing temperature of the lubricant.
